(19) United States
(12) Patent Application Publication
(10) Pub. No.: US 2008/0013190 A1
(43) Pub. Date: Jan. 17, 2008

(54) Structure of cam barrel for zoom lens

(75) Inventor: Atsushi Oshima, Yokohama-shi (JP)

Correspondence Address: LADAS & PARRY, 26 WEST 61ST STREET, NEW YORK, NY, 10023, US

(73) Assignee: NATEC ENGINEERING CORPORATION

(21) Appl. No.: 11/485,804

(22) Filed: Jul. 13, 2006

(51) Int. Cl. G02B 15/14

(52) U.S. Cl. 359/699

(57) ABSTRACT

A high-precision cam barrel for a zoom lens without a slide mold and a method of manufacturing the cam barrel through a simple mold are provided. The cam barrel for a zoom lens includes one or more lens groups, a cam barrel having one or more cam slots to guide the lens groups to move back and forth by being rotated clockwise or anti-clockwise, and one or more guide mechanisms for controlling the lens groups to move back and forth in parallel with an optical axis. The cam barrel is characterized by being formed with multiple sub-cam barrels by means of combination, wherein the sub-cam barrels are formed in advance into a shape which is divided along lines partitioning two side surfaces forming each of the cam slots.

### BACKGROUND OF THE INVENTION

1. Field of Invention

The present invention relates to a structure of a zoom lens unit and a camera adopting the zoom lens unit, and more particularly, to an improved structure of a cam barrel for a zoom lens, a camera adopting the same, and a method of manufacturing the same.

2. Related Art

Generally, a cam barrel for moving the positions of multiple lens groups is built in a zoom lens. Various optical designs may be used in the zoom lens. However, herein, a zoom lens having a lens group 3, a lens group 4 and a lens group 5 is taken as an example for illustration, wherein the lens groups 4 functions as a variator for changing the size of an image, and the lens group 3 functions as a compensator to compensate for the focus offset caused by zooming.

Referring to FIGS. 1 and 2, FIG. 1 is an exploded view of the constitution of the conventional zoom lens unit as described above, and FIG. 2 is a diagram representing the state of the conventional zoom lens unit after assembly. The lens groups 3, 4, and 5 are respectively mounted in plastic frames 34, 44, and 54, and pins 31, 32, and 33 and pins 41, 42, and 43 are respectively jointed in the peripheries of the plastic frames 34 and 44. Furthermore, the plastic frame 54 is fixed on a base 6.

Furthermore, a cam slot group 16 and a cam slot group 17 are scribed in a cam barrel 1, which accommodates the lens groups 3 and 4. Each of the cam slot groups 16 and 17 respectively includes cam slots of the same shape, i.e., cam slots 161, 162, and 163, and cam slots 171, 172, and 173, disposed in the cam barrel 1 in a circumferential direction. As described above, in order to stabilize the lens groups 3 and 4 when they are being moved and prevent the lens groups 3 and 4 from inclining with respect to an optical axis, the cam slot group 16 must comprise three cam slots 161, 162 and 163 and the three pins 31, 32 and 33, and the cam slot group 17 must comprise the three cam slots 171, 172 and 173 and the three pins 41, 42 and 43. A gear 18 is formed on the bottom of the cam barrel 1 and driven by an external driving system (not shown) to rotate, so as to make the cam barrel 1 rotate as a whole, such that the lens groups 3 and 4 embedded in the cam slot groups 16 and 17 move up and down, tracing the shape of the cam slot groups 16 and 17.

A guide mechanism 2 is further disposed between the cam barrel 1 and the lens groups 3 and 4, and is fixed on the base 6 by various means, such as fastening screws. The guide mechanism 2 is a mechanism for preventing the lens groups 3 and 4 from rotating with the cam barrel 1 and preventing the vibration in the outer circumferential direction. Three linear guide slots 21, 22, and 23 parallel to the optical axis direction are slotted in the outer circumference of the barrel-shaped means of the guide mechanism 2. As described above, since the pins 31, 32 and 33 of the frame 34 of the lens group 3 and the pins 41, 42 and 43 of the frame 44 of the lens group 4 respectively embedded into the cam barrel slot groups 16 and 17 are also embedded into the guide slots 21, 22 and 23, the cam barrel 1 begins to rotate as a whole through the driving system, such that when moving up and down to trace the shape of the cam slot group 16, 17, due to the restriction of the inner side of the guide slots 21, 22 and 23 and the guide mechanism 2, the lens groups 3 and 4 may move up and down in the direction parallel with the optical axis without being rotated and causing vibration of the outer circumference.

Moreover, FIG. 3 is a diagram representing the usage of the zoom of the zoom lens unit, wherein FIG. 3(a) represents a Tele state, FIG. 3(b) represents a middle state, and FIG. 3(c) represents a Wide state. When the cam barrel 1 is rotated, the lens groups 3 and 4 are run as shown in FIGS. 3(a)-3(c) to be changed into the Wide state, the Tele state, and a middle state therebetween. As such, a user may adjust the zoom of the camera, i.e., the focal length of the lens.

Since a common mold is opened/closed only in one direction, when an undercut portion, such as concavo-convex or a horizontal hole formed in the side surface of the formed piece, is formed in a finished product, the plastic formed therein will be seized, such that the mold cannot be opened/closed. When the aforementioned cam barrel 1 is adopted, since the cam slots on the side surface of the cam barrel become undercut portions, the common mold cannot be used to realize the molding. Therefore, conventionally, an expensive slide mold must be used to realize plastic molding.

The slide mold may be a slide core die and a split die. A hole is formed in a side surface of the die to make the slide core die the type in which the slide core is moved in and out in the horizontal direction. During the molding, a mobile die is dropped to the lower part to be sealed with a fixed die. In cooperation with such operation, the slide core protrudes in a die cavity. Afterwards, a plastic material that has been melted at a high temperature is injected into the die cavity and it becomes hard as the temperature decreases. When the plastic material becomes hard, the mobile die is raised to the upper part. At this point, since the slide core is driven to move laterally, the formed parts may be taken out without being seized.

Moreover, as for the split die, the die is divided into several parts, wherein some parts are moved in the horizontal direction. During molding, the mobile die is dropped to the lower part. In cooperation with such operation, the circumferential split dies are moved to the center for forming a die cavity for molding. Afterward, similar to the above, a plastic material is injected into the die cavity, and when the plastic material becomes hard, the mobile die is raised to the upper part. At this point, since the circumferential split dies are driven to move laterally, the formed parts may be taken out without being seized.

FIGS. 4(a) and 4(b) are diagrams representing an example of forming the cam barrel 1 with the conventional slide mold. FIG. 4(a) represents the state in which the slide mold 7 is closed and FIG. 4(b) represents the state in which the slide mold is opened after the cam barrel is formed. The slide mold in FIGS. 4(a) and 4(b) is one of the aforementioned split dies. As shown in FIG. 4(b), in order to manufacture the cam barrel 1 for a zoom lens integrated into one piece and comprising the cam slot groups 16 and 17, which respectively comprise the cam slots 161, 162, and 163 of the same shape and the cam slots 171, 172, and 173 of the same shape in the circumferential direction, the slide mold 7 must comprise the split dies 72, 73, and 74, which can be slid and are apart from one another in three different directions. After the cam barrel 1 is formed, a cover 71 of the slide mold 7 is removed, as shown by the arrow in the drawing, and the split dies 72, 73, and 74 of the slide mold toward three different directions are made to slide laterally respectively, thereby taking out the cam barrel 1 which is initially formed.

As for the slide mold 7 with the split dies 72, 73, and 74 toward three different directions, since rod shaped protrusions 411, 412 and 413, and rod shaped protrusions 421, 422 and 423 for respectively die cutting the cam slots 161, 162 and 163, and the cam slots 171, 172 and 173 must be formed on the inner wall, compared with the common mold, the slide mold 7 is more complicated, difficult to be manufactured, and has a higher cost. Moreover, as described above, in order to take out the formed cam barrel 1 from the mold, the split dies 72, 73, and 74 must slide in three different directions. Since a high precision and a long time are necessary for manufacturing a die with such structure, the operation is quite complicated and difficult. Furthermore, in order to focus precisely in the whole zoom area, the rod-shaped protrusions 411, 412 and 413 and the rod-shaped protrusions 421, 422 and 423 which may precisely form the cam slots 161, 162 and 163 and the cam slots 171, 172 and 173 for a zoom lens must be manufactured. Therefore, the conventional art has the problem that each time the zoom lens unit is designed and developed, in order to manufacture the 3-direction slide mold 7 which may form the cam barrel 1 containing the highly precise cam slots 161, 162 and 163 and the highly precise cam slots 171, 172 and 173, a high cost and long manufacturing time are inevitable.

### SUMMARY OF THE INVENTION

In view of such situation, one object of the present invention is to provide a high-precision cam barrel for a zoom lens that can be manufactured through a simple mold without using a slide mold and a method of manufacturing the same.

The present invention is different from the conventional cam barrel integrated into one piece. For the present invention, the cam barrel is divided into multiple parts, which are jointed together by means of combination, thereby forming the cam barrel of the same shape as the cam barrel integrated into one piece. The multiple parts may be formed through any simple mold instead of the slide type.

Particularly, in order to achieve the aforementioned object, the cam barrel for a zoom lens of Claim 1 of the present invention comprises a cam barrel having one or more cam slots to guide one or more lens groups to move back and forth by being rotated clockwise or anti-clockwise, and one or more guide mechanisms for controlling the lens groups to move back and forth in parallel with an optical axis, wherein the cam barrel is formed with multiple sub-cam barrels by means of combination, and the sub-cam barrels are formed in advance into a shape which is divided along lines partitioning two side surfaces forming each of the cam slots.

Moreover, the cam barrel for a zoom lens in Claim 2 of the present invention is the same as the cam barrel for a zoom lens in Claim 1, wherein each sub-cam barrel is formed into a shape which is divided along the lines partitioning the two side surfaces forming each slot of the cam slot group of the same shape, and the cam slot group comprises cam slots of the same shape.

Moreover, the cam barrel for a zoom lens in Claim 3 of the present invention is the same as the cam barrel for a zoom lens in Claims 1 and 2, wherein the sub-cam barrels are formed into a shape for being engaged with other adjacent sub-cam barrels.

Moreover, the cam barrel for a zoom lens in Claim 4 of the present invention is the same as the cam barrel for a zoom lens in any one of Claims 1-3, wherein the cam barrel for a zoom lens comprises three aforementioned sub-cam barrels.

Moreover, the cam barrel for a zoom lens in Claim 5 of the present invention is the same as the cam barrel for a zoom lens in any one of Claims 1-4, wherein the aforementioned sub-cam barrels are jointed together by means of adhesion.

Moreover, the cam barrel for a zoom lens in Claim 6 of the present invention is the same as the cam barrel for a zoom lens in any one of Claims 1-4, wherein the aforementioned sub-cam barrels are jointed together through fastening screws.

In order to achieve the aforementioned object, in the method of manufacturing the cam barrel for a zoom lens in Claim 7 of the present invention, the cam barrel for a zoom lens comprises a cam barrel having one or more cam slots to guide one or more lens groups to move back and forth by being rotated clockwise or anti-clockwise, and one or more guide mechanisms for controlling the lens groups to move back and forth in parallel with an optical axis, wherein the cam barrel is formed with multiple sub-cam barrels by means of combination, and the sub-cam barrels are formed in advance into a shape which is divided along lines partitioning two side surfaces forming each of the cam slots.

Moreover, the method of manufacturing the cam barrel for a zoom lens in Claim 8 of the present invention is the same as the method of manufacturing the cam barrel for a zoom lens in Claim 7, wherein the sub-cam barrels are formed into a shape which is divided along the lines partitioning the two side surfaces forming each of the cam slots of the cam slot groups of the same shape, and the cam slot groups comprise cam slots of the same shape.

Moreover, the method of manufacturing the cam barrel for a zoom lens in Claim 9 of the present invention is the same as the method of manufacturing the cam barrel for a zoom lens in Claim 7 and 8, wherein the sub-cam barrels are formed into a shape for being engaged with other adjacent sub-cam barrels.

Moreover, the method of manufacturing the cam barrel for a zoom lens in Claim 10 of the present invention is the same as the method of manufacturing the cam barrel for a zoom lens in any one of Claims 7-9, wherein the aforementioned sub-cam barrels are jointed together by means of adhesion.

Moreover, the method of manufacturing the cam barrel for a zoom lens in Claim 11 of the present invention is the same as the method of manufacturing the cam barrel for a zoom lens in any one of Claims 7-9, wherein the aforementioned sub-cam barrels are jointed together through fastening screws.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which is not limitative of the present invention, and wherein:

FIG. 1 is an exploded view of the constitution of the conventional zoom lens unit;

FIG. 2 is a diagram representing the state of the conventional zoom lens unit after being assembled;

FIGS. 3(a), 3(b), and 3(c) are diagrams representing the usage of the zoom of the zoom lens unit, wherein FIG. 3(a) represents a Tele state, FIG. 3(b) represents a middle state, and FIG. 3(c) represents a Wide state;

FIGS. 4(a) and 4(b) are diagrams representing an example in which the conventional slide mold is used to form the cam barrel 1, wherein FIG. 4(a) represents the state in which the slide mold 7 is closed and FIG. 4(b) represents the state in which the conventional slide mold is opened;

FIG. 5 is a diagram representing the sub-cam barrels of the cam barrel for a zoom lens according to Embodiment 1 of the present invention;

FIG. 6 is a diagram representing the sub-cam barrels in Embodiment 1 after being jointed together;

FIG. 7 shows sectional views when the molds for forming each sub-cam barrel are closed and resin material is injected, wherein FIG. 7(a) is a die section of the upper part,

FIG. 7(b) is a die section of the middle part, and FIG. 7(c) is a die section of the lower part;

FIG. 8 shows sectional views when the molds for forming each sub-cam barrel are opened and each sub-cam barrel is taken out, wherein FIG. 8(a) is a die section of the upper part, FIG. 8(b) is a die section of the middle part, and FIG. 8(c) is a die section of the lower part;

FIG. 9 is a diagram representing the sub-cam barrels of the cam barrel for a zoom lens according to Embodiment 2 of the present invention;

FIG. 10 is a diagram representing the sub-cam barrels in Embodiment 2 after being jointed together;

FIG. 11 is a diagram of the sub-cam barrels of the cam barrel for a zoom lens according to Embodiment 3 of the present invention;

FIG. 12 is a structural diagram of the zoom lens unit according to Embodiment 3 of the present invention; and

FIGS. 13(a)-13(c) are sectional views representing the usage of the zoom of the zoom lens unit in Embodiment 3 of the present invention, wherein FIG. 13(a) represents a Tele state, FIG. 13(b) represents a middle state, and FIG. 13(c) represents a Wide state.

### DETAILED DESCRIPTION OF THE INVENTION

Referring to the accompanied drawings, preferred embodiments of the structure of the cam barrel for a zoom lens provided by the present invention will be illustrated in detail as follows.

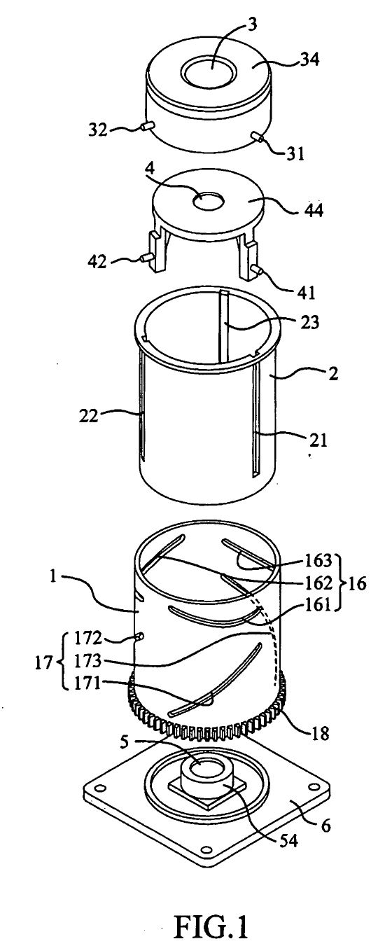

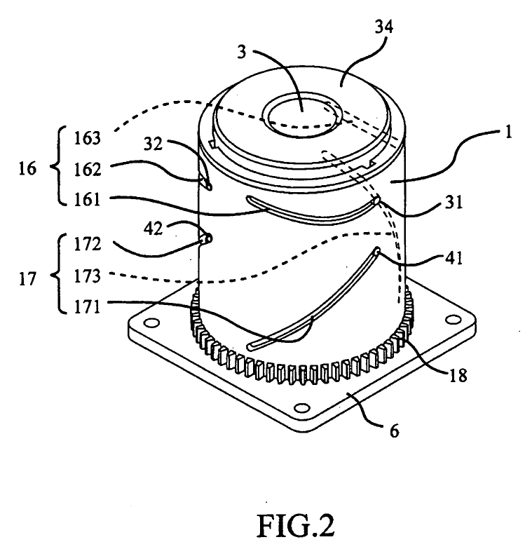

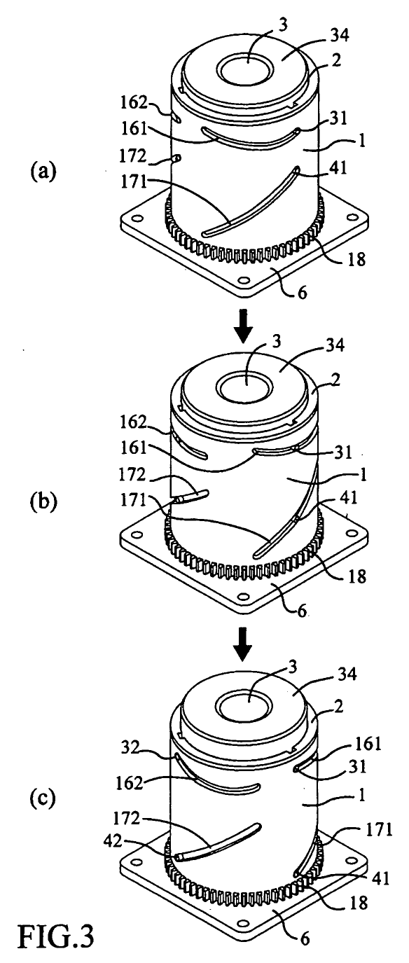

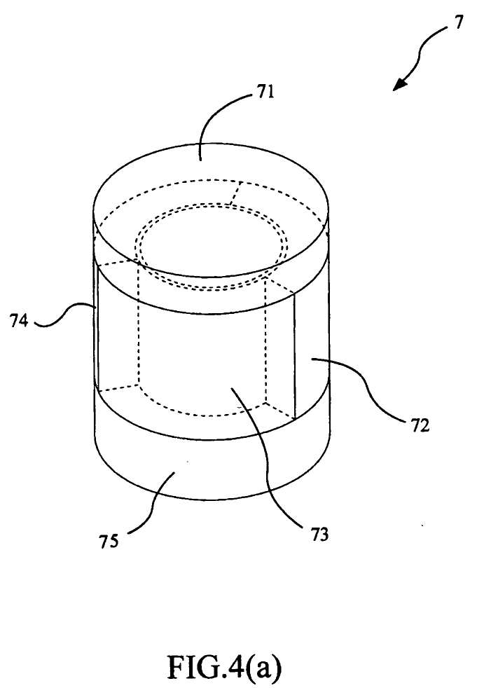

The structure of the cam barrel 1 of the embodiments of the present invention is different from the conventional zoom lens unit, but other identical means are represented by the same numerals as the means of the zoom lens shown in FIGS. 1-3.

### Embodiment 1

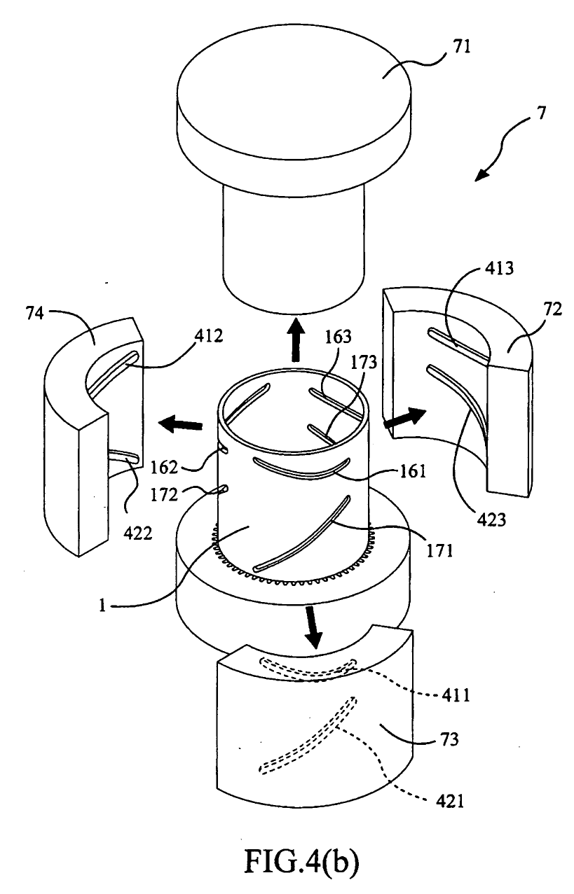

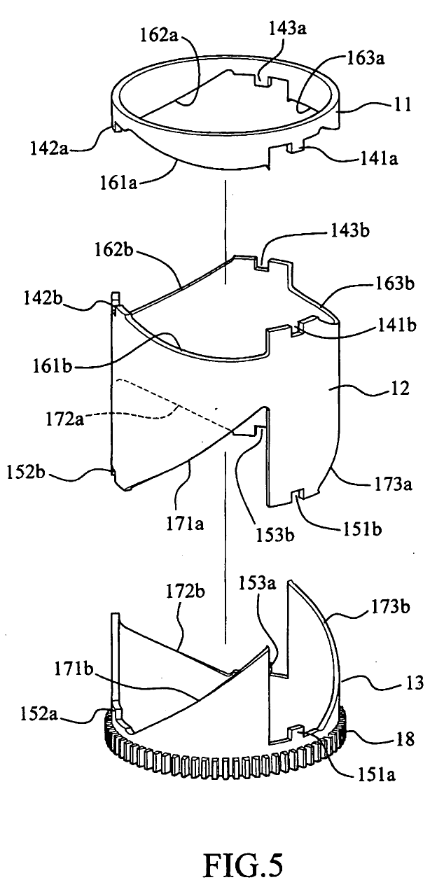

FIG. 5 is a diagram representing the sub-cam barrels 11, 12, and 13 of the cam barrel 1 for a zoom lens according to Embodiment 1 of the present invention, and FIG. 6 is a diagram representing the sub-cam barrels 11, 12, and 13 in Embodiment 1 of the present invention after being jointed. As shown in FIG. 5, in the present invention, as described before, a cam barrel 1 used to guide the lens groups 3 and 4 to move back and forth by being rotated clockwise or anti-clockwise is formed into multiple sub-cam barrels 11, 12, and 13 in advance, according to the shape which is divided along the lines partitioning the two shapes (among the cam slot edge surfaces 161a, 162a, 163a, 161b, 162b, and 163b and the cam slot edge surfaces 171a, 172a, 173a, 171b, 172b, and 173b) forming each of the cam slots 161, 162 and 163 and the cam slots 171, 172 and 173 of the cam slot groups 16 and 17. Since each of the sub-cam barrels 11, 12 and 13 does not comprise an undercut portion, the sub-cam barrels 11, 12, and 13 may be respectively formed through the conventional common molds.

Moreover, upon being formed, the sub-cam barrels 11, 12, and 13 are sequentially combined and jointed together through an adhesion method, fastening screws, or another method, thereby forming the cam barrel 1, as shown in FIG. 6.

If the sub-cam barrels 11, 12, and 13 are formed into a shape which is divided along the lines partitioning the two side surfaces (among the edge surfaces 161a, 162a, 163a, 161b, 162b, and 163b and the edge surfaces 171a, 172a, 173a, 171b, 172b, and 173b of the cam slots) of each of the cam slots 161, 162, and 163 and the cam slots 171, 172, and 173 of the cam slot groups 16 and 17, as described before, the sub-cam barrels 11, 12, and 13 may be formed without slide molds. Various shapes of the cam slot may be achieved through the optical designs of the zoom lens and any shape can divide the cam barrel into an upper part and a lower part at the positions of the cam slots. As shown in FIG. 5, preferably, the multiple sub-cam barrels 11, 12, and 13 are formed into a shape which is divided along the lines partitioning the two side surfaces of the cam slots 161, 162, and 163 and the cam slots 171, 172, and 173 of the cam slot groups 16 and 17 of the same shape, wherein the cam slot groups 16 and 17 comprise the cam slots 161 and 171 of the same shape. As shown in FIG. 5, the cam slots 161, 162, and 163 of the cam barrel 1 comprise the cam slot edge surfaces 161a, 162a, and 163a of the sub-cam barrel 11 and the cam slot edge surfaces 161b, 162b, and 163b of the sub-cam barrel 12 which are adjacent to one another, and the cam slots 171, 172, and 173 of the cam barrel 1 comprise the cam slot edge surfaces 171a, 172a, and 173a of the sub-cam barrel 12 and the cam slot edge surfaces 171b, 172b, and 173b of the sub-cam barrel 13 which are adjacent to one another, thereby forming the cam barrel of the functioning like the conventional one.

Furthermore, in order to make the sub-cam barrels 11, 12, and 13 adjacent to one another joint precisely without any offset, as for the shapes of the jointing positions of the sub-cam barrels 11, 12, and 13, protrusions 141a, 142a, 143a are disposed on the sub-cam barrel 11 and protrusions 151a, 152a, and 153a are disposed on the sub-cam barrel 13, and preferably, recesses 141b, 142b, and 143b and the recesses 151b, 152b, and 153b are disposed on the sub-cam barrel 12 to be engaged with the protrusions. In order to engage the protrusions 141a, 142a, and 143a and the recesses 141b, 142b, and 143b, and engage the protrusions 151a, 152a, and 153a and the recesses 151b, 152b, and 163b, the sub-cam barrels 11, 12, and 13 are assembled and jointed together at the engaging positions through an adhesion method, fastening screws or another method.

As described above, the protrusions 141a, 142a, and 143a, the protrusions 151a, 152a, and 153a, and the recesses 141b, 142b, 143b, 151b, 152b, and 153b are formed respectively at the jointing positions of the sub-cam barrels 11, 13, and 12, so as to position the sub-cam barrels 11, 12, and 13 adjacent to each other immediately and joint them together at specific positions in a circumferential direction precisely without any offset, thereby saving the operating time of keeping the sub-cam barrels 11, 12, and 13 at specific positions. Moreover, the lens groups 3 and 4 are guided by the cam slots 161, 162, and 163 comprising the adjacent cam slot edge surfaces 161a, 162a, and 163a of the sub-cam barrel 11 and the cam slot edge surfaces 161b, 162b, and 163b of the sub-cam barrel 12 and the cam slots 171, 172, and 173 comprising the adjacent cam slot edge surfaces 171a, 172a, and 173a of the sub-cam barrel 12 and the cam slot edge surfaces 171b, 172b, and 173b of the sub-cam barrel 13, so as to further trace the high-precision cam slot groups 16 and 17 to move up and down, wherein the cam slot groups 16 and 17 comprise the cam slots of the same shape.

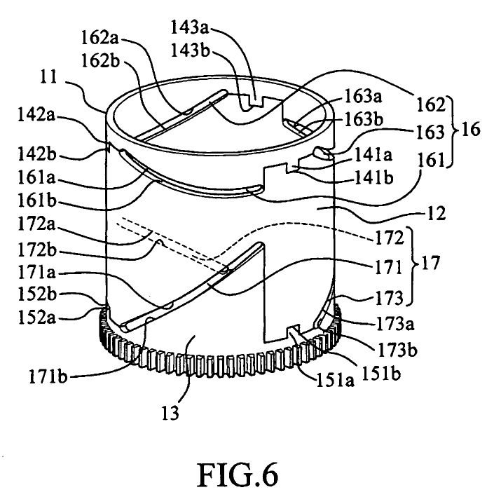

FIG. 7 shows sectional views when the molds 81, 82, and 83 for forming each of the sub-cam barrels 11, 12, and 13 are closed and resin material is injected, wherein FIG. 7(a) is a die section of the upper part, FIG. 7(b) is a die section of the middle part, and FIG. 7(c) is a die section of the lower part. As shown in FIGS. 7(a)-7(c), the die sections of the sub-cam barrels 11, 12, and 13 are of single shapes and have no undercut portions. Furthermore, FIGS. 7(a)-7(c) represent the sections from only one angle; however, the section of each of the sub-cam barrels 11, 12, and 13 from any angle is also a single shape which has no undercut portion.

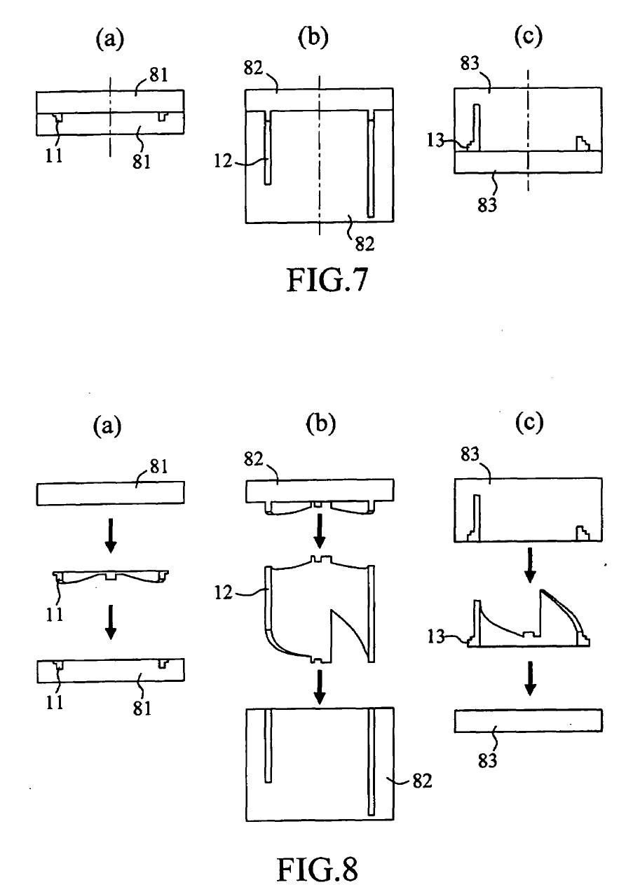

Furthermore, FIG. 8 shows sectional views when the molds 81, 82, and 83 for forming each of the sub-cam barrels 11, 12, and 13 are opened and each of the sub-cam barrels 11, 12, and 13 is taken out, wherein FIG. 8(a) is a die section of the upper part, FIG. 8(b) is a die section of the middle part, and FIG. 8(c) is a die section of the lower part. It can be known from the sectional views in FIG. 8 that in the present invention, since the cam barrel 1 is divided into the sub-cam barrels 11, 12, and 13 according to a shape which is divided along lines partitioning two side surfaces forming each of the cam slots 161 and 171 of the cam slot groups 16 and 17, the section of each of the sub-cam barrels 11, 12, and 13 is of a single shape from any angle. Since no under portions exist, after being formed, each of the sub-cam barrels 11, 12, and 13 may be drawn out vertically.

### Embodiment 2

In Embodiment 1, the cam slots 161, 162, and 163 and the cam slots 171, 172, and 173 are formed as holes, but can also be discontinuous slots. That is, the method provided by the present invention is also applicable in an inner-faced cam barrel of a concave cam slot formed on the inner face of the cam barrel 1. The structure of the cam barrel for a zoom lens in Embodiment 2 is of an inner-face type, wherein the discontinuous concave cam slots are formed on the inner face of the cam barrel 10.

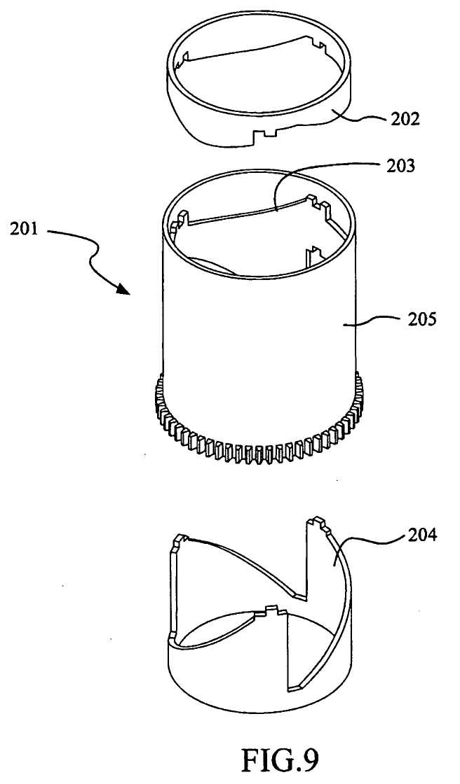

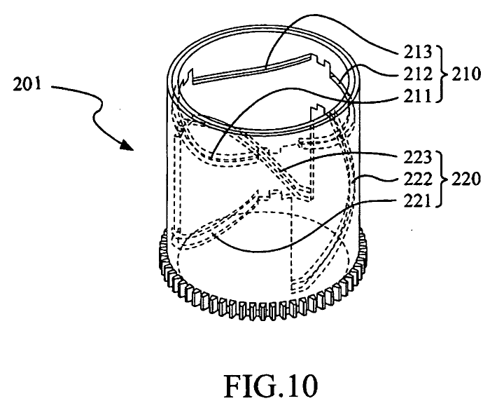

FIG. 9 is a diagram representing the sub-cam barrels of the cam barrel for a zoom lens according to Embodiment 2 of the present invention; FIG. 10 is a diagram representing the cam barrel 201 for a zoom lens in Embodiment 2 after the sub-cam barrels are jointed together.

As shown in FIG. 9, in Embodiment 2, the cam barrel is divided into multiple sub-cam barrels 202, 203, and 204 in advance according to the shape which is divided along the lines partitioning the two side surfaces (the cam slot edge surfaces) forming each of the cam slots 211, 212, 213, 221, 222, and 223 of the cam slot groups 210 and 220, which is the same as Embodiment 1 except that a wall 205 is formed around the sub-cam barrel 203, wherein the wall 205 becomes the outer wall of the cam barrel 201.

Even in Embodiment 2, no undercut portion exists in each of the sub-cam barrels 202, 203, and 204, so the conventional mold instead of a slide mold may be used to form the sub-cam barrels 202, 203, and 204.

Furthermore, after being formed, the sub-cam barrels 202, 203, and 204 are sequentially jointed through an adhesion method, fastening screws or another method, which is the same as Embodiment 1. Thereby, as shown in FIG. 10, the cam barrel 201 with discontinuous concave cam slots 211, 212, 213, 221, 222, and 223 formed on the outer surface is formed.

Preferably, the sub-cam barrels 202, 203, and 204 are formed through a method which is the same as Embodiment 1, i.e., through the method of dividing and forming. Furthermore, in order to precisely joint the sub-cam barrels 202, 203, and 204 adjacent to one another without any offset, preferably, protrusions and recesses are respectively disposed at the jointing positions of the sub-cam barrels 202, 203, and 204. Additionally, the engaging positions are jointed through an adhesion method, fastening screws or another method.

### Embodiment 3

As described in Embodiment 1, as for the structure of the cam barrel for a zoom lens in Embodiment 3 of the present invention, instead of three cam slots of the same shape, only one cam slot is disposed on the circumference at the same height level.

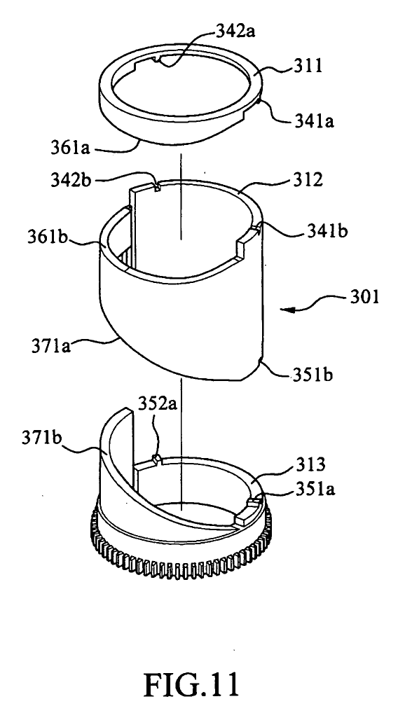

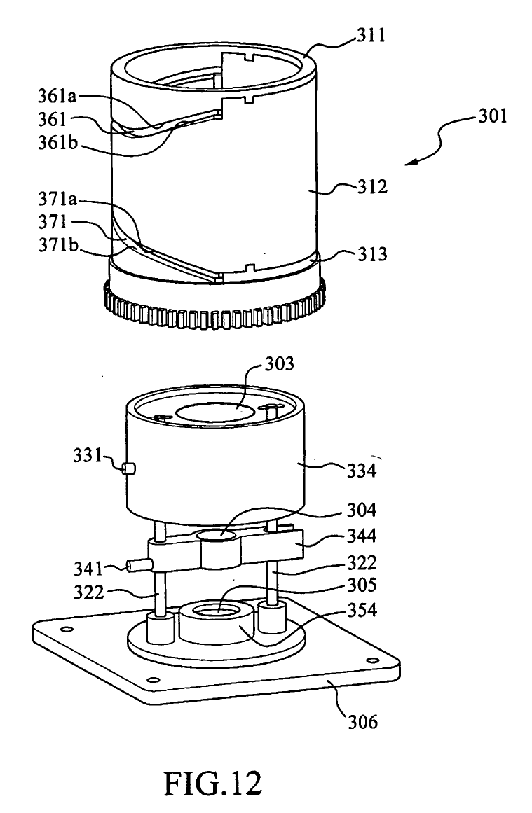

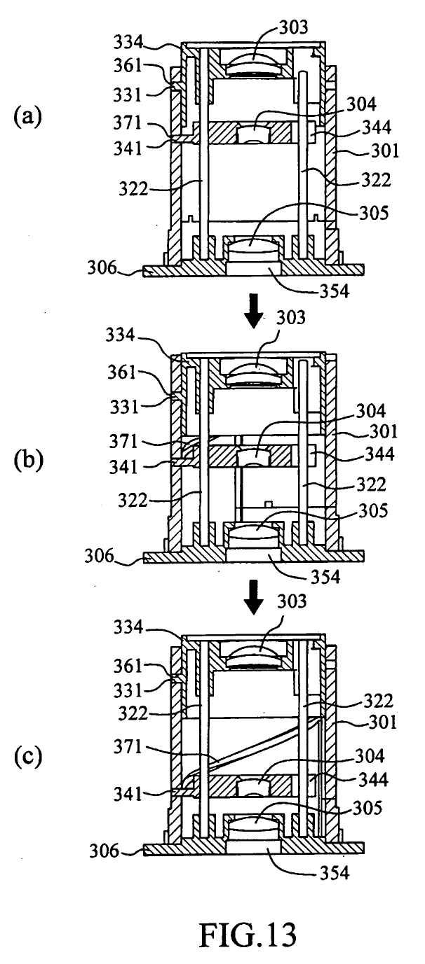

FIG. 11 is a diagram representing the sub-cam barrels 311, 312, and 313 of the cam barrel 301 for a zoom lens according to Embodiment 3 of the present invention. FIG. 12 is a structural diagram of the zoom lens unit according to Embodiment 3 of the present invention. FIGS. 13(a)-13(c) are sectional views representing the usage of the zoom of the zoom lens unit in Embodiment 3 of the present invention, wherein FIG. 13(a) represents a Tele state, FIG. 13(b) represents a middle state, and FIG. 13(c) represents a Wide state.

In Embodiment 3, the lens groups 303, 304, and 305 are mounted on the plastic frames 334, 344, and 354, and the pins 331 and 341 are jointed or formed respectively at one position around the frames 334 and 344. Furthermore, the frame 354 is fixed on the base 306.

As shown in Embodiment 3, the pins 331 and 341 are respectively disposed at only one position around the frames 334 and 344, and in a lens unit on which only the cam slots 361 and 371 are disposed on the same circumference of the cam barrel 301, since the lens groups 303 and 304 are vibrated centrally or tilted, as shown in FIG. 12, guide shafts 322 are disposed, such that the lens groups 303 and 304 may be moved along the guide shafts 322, thereby preventing the lens groups 303 and 304 from vibrating centrally and tilting.

As shown in FIG. 11, in Embodiment 3, the cam barrel 301 is used to guide the lens groups 303 and 304 to move back and forth by being rotated clockwise or anti-clockwise, and is divided into the sub-cam barrels 311, 312, and 313 in advance according to a shape which is divided along the lines partitioning the two side surfaces (among the cam slot edge surfaces 361a, 361b, 371a, and 371b) forming each of the cam slots 361 and 371. Since each of the sub-cam barrels 311, 312, and 313 does not have any undercut portion, the conventional mold may be used to form the sub-cam barrels 311, 312, and 313.

Furthermore, when being formed, the sub-cam barrels 311, 312, and 313 are sequentially jointed through an adhesion method, fastening screws, or another method, thereby forming the cam barrel 301, as shown in FIG. 12.

If the sub-cam barrels 311, 312, and 313 are divided according to a shape which is divided along the lines partitioning the two side surfaces (among the cam slot edge surfaces 361a, 361b, 371a, and 371b) forming each of the cam slots 361 and 371, the sub-cam barrels 311, 312, and 313 may be any shape and need not be formed through a slide mold, which is the same as described above. As shown in FIG. 11, preferably, the sub-cam barrels 311, 312, and 313 are formed into a shape which is divided by the lines partitioning the two side surfaces forming each of the cam slots and the circular order of the cam barrel 1 being cut in the horizontal direction in the part where the cam slots 361 and 371 are removed. However, the shape also may be divided through connecting the two sides of the cam slots 361 and 371 along the lines that are not the circular curve for cutting the cam barrel 1 in the horizontal direction.

As shown in FIG. 12, the cam slot 361 of the cam barrel 301 comprises a cam slot edge surface 361a of the sub-cam barrel 311 and a cam slot edge surface 361b of the sub-cam barrel 312 which are adjacent to each other, and the cam slot 371 of the cam barrel 301 comprises a cam slot edge surface 371a of the sub-cam barrel 312 and the cam slot edge surface 371b of the sub-cam barrel 313 which are adjacent to each other, thereby manufacturing the cam barrel 301 of the same function which is the same as the conventional art.

Moreover, in order to precisely joint the adjacent sub-cam barrels 311, 312, and 313 without any offset, preferably, as for the shape of the jointing position of each of the sub-cam barrels 311, 312, and 313, protrusions 341a and 342a are disposed on the sub-cam barrel 311, protrusions 351a and 352a are disposed on the sub-cam barrel 313, and the recesses 341b and 342b and the recesses 351b and 352b for being engaged with each of the protrusions are disposed on the sub-cam barrel 312. In order to engage the protrusions 341a and 342a and the recesses 341b and 342b, and engage the protrusions 351a and 352b and the recesses 351b and 352b, the sub-cam barrels 311, 312, and 313 are jointed together through an adhesion method, fastening screws, or another method.

Furthermore, even in Embodiment 3, the cam slots 361 and 371 are formed as holes; however, as described in Embodiment 2, they may also be discontinuous slots.

As described above, the protrusions 341a, 342a, the protrusions 351a, 352a, and the recesses 341b, 342b, 351b, and 352b are respectively formed at the jointing positions of the sub-cam barrels 311, 313, and 312, so as to position the sub-cam barrels 311, 312, and 313 adjacent to each other immediately and joint them together at specific positions in a circumferential direction precisely without any offset, thereby saving the operating time of keeping the sub-cam barrels 311, 312, and 313 at specific positions. Moreover, the lens groups 303 and 304 are guided by the cam slot 361 comprising the adjacent cam slot edge surfaces 361a and 361b of the sub-cam barrel 311 and 312 and the cam slot 371 comprising the adjacent cam slot edge surfaces 371a and 371b of the sub-cam barrel 312 and 313, so as to further trace the cam slot 361 and 371 to move up and down with higher precision.

Moreover, when the cam barrel 1 is rotated, the lens groups 303 and 304 are run as shown in FIGS. 13(a)-13(c) to be changed into the Wide status, the Tele status, and a middle status therebetween. As such, a user may adjust the zoom of the camera, i.e., the focal length of the lens.

Additionally, in Embodiment 3, the cam slots 361 and 371 are respectively disposed on the two positions on the circumference at the same level, but two or more cam slots of different shapes may also be disposed, such that multiple lens groups 303 and 304 may move differently along the guide shafts 322.

Usefulness in Industry

As described above, in the present invention, the simple molds 81, 82, and 83, which may be used to manufacture a cam barrel, conventionally have to be manufactured through a slide mold 7 towards multiple directions, thereby greatly reducing the manufacturing cost of the molds 81, 82, and 83.

Furthermore, since the slide mold 7 that is hard to be manufactured is unnecessary, even a manufacturer with poor technology for manufacturing the slide mold 7 may manufacture the cam barrel through a simple mold.

Furthermore, compared with the situation that cam slots are manufactured through protrusions 73 disposed at the slide mold 7, the precision of the cam slots is easily enhanced.

Furthermore, within the spirit and scope of the present invention, the invention is applicable in the zoom lens units of various cameras, such as a silver salt camera, a digital camera or a video camera, a camera used in a mobile phone, and a camera used in an MP3 player.

The invention being thus described, it will be obvious that the same may be varied in many ways. Such variations are not to be regarded as a departure from the spirit and scope of the invention, and all such modifications that would be obvious to one skilled in the art are intended to be included within the scope of the following claims.

1. A cam barrel for a zoom lens, comprising a cam barrel having one or more cam slots to guide one or more lens groups to move back and forth by being rotated clockwise or anti-clockwise; and one or more guide mechanisms for controlling the lens groups to move back and forth in parallel with an optical axis, wherein the cam barrel is formed with multiple sub-cam barrels by means of combination, and the sub-cam barrels are formed in advance into a shape which is divided along lines partitioning two side surfaces forming each of the cam slots.

2. The cam barrel for a zoom lens as claimed in claim 1, wherein each sub-cam barrel is formed into a shape which is divided along the lines partitioning the two surfaces forming each of the cam slots of the cam slot group of the same shape, and the cam slot group comprises the cam slots of the same shape.

3. The cam barrel for a zoom lens as claimed in claim 1, wherein the sub-cam barrel is formed into a shape that is able to be engaged with other adjacent sub-cam barrels.

4. The cam barrel for a zoom lens as claimed in claim 1, comprising three sub-cam barrels. The cam barrel for a zoom lens as claimed in claim 1, wherein the sub-cam barrels are jointed by means of adhesion.

6. The cam barrel for a zoom lens as claimed in claim 1, wherein the sub-cam barrels are jointed through fastening screws.

7. A method of manufacturing a cam barrel for a zoom lens, the cam barrel for a zoom lens comprising a cam barrel having one or more cam slots to guide one or more lens groups to move back and forth by being rotated clockwise or anti-clockwise; and one or more guide mechanisms for controlling the lens groups to move back and forth in parallel with an optical axis, wherein multiple sub-cam barrels combine to form the cam barrel, the sub-cam barrels being formed in advance into a shape which is divided along the lines partitioning two side surfaces forming each of the cam slots.

8. The method of manufacturing the cam barrel for a zoom lens as claimed in claim 7, wherein each sub-cam barrel is formed into a shape which is divided along the lines partitioning the two surfaces forming each of the cam slots of the cam slot group of the same shape, and the cam slot group comprises the cam slots of the same shape.

9. The method of manufacturing the cam barrel for a zoom lens as claimed in claim 7, wherein the sub-cam barrel is formed into a shape that is able to be engaged with other adjacent sub-cam barrels.

10. The method of manufacturing the cam barrel for a zoom lens as claimed in claim 7, wherein the sub-cam barrels are jointed by means of adhesion.

11. The method of manufacturing the cam barrel for a zoom lens as claimed in claim 7, wherein the sub-cam barrels are jointed through fastening screws.
